(19) United States
(12) Patent Application Publication
(10) Pub. No.: US 2007/0157780 A1
(43) Pub. Date: Jul. 12, 2007

(54) FOAM BOARD CUTTING MACHINE

(75) Inventors: Wai Fung Chan, Hong Kong (HK); Po Man Lai, Hong Kong (HK); Shu Kie Law, Hong Kong (HK)

Correspondence Address: INTELLECTUAL PROPERTY LAW GROUP LLP, 12 SOUTH FIRST STREET, SUITE 1205, SAN JOSE, CA, 95113, US

(73) Assignee: ARTRAIN INDUSTRIAL LIMITED, Hong Kong (HK)

(21) Appl. No.: 11/456,716

(22) Filed: Jul. 11, 2006

(30) Foreign Application Priority Data
Jan. 9, 2006 (HK) 06100330.3

(51) Int. Cl. B26D 7/10

(52) U.S. Cl. 83/171; 83/651.1

(57) ABSTRACT

A machine is disclosed for cutting a piece of styrofoam or like material. This styrofoam cutting machine comprises a working platform, a support arm fixed on the working platform, a heating wire attached to the end of the support arm, and a protective mantle that is positioned around the heating wire. The protective mantle around the heating wire prevents the machine operator from coming into direct contact with the heating wire and thus prevents accidents, making the operation safer and more reliable.

### FIELD OF THE INVENTION

The present invention relates to a cutting machine, and more particularly, to a foam or styrofoam board cutting machine having a protective mantle.

### BACKGROUND OF THE INVENTION

Styrofoam boards with specific shapes are often used in many fields such as in the manufacturing of children's toys. The required specific shapes of the styrofoam boards are achieved by cutting the boards with a cutting machine. Normally, the machine consists of a working platform on which the styrofoam board is placed, a support arm fixed on one side of the platform and extended over the top of the platform, and a heating wire set on the back portion of the support arm. To cut the styrofoam board into a specific shape, the styrofoam is moved around on the platform while the unwanted parts are cut off by the heated, high-temperature wire. However, this cutting process is very dangerous because the heated wire is exposed while the machine operator is moving the styrofoam and the operator may accidentally make contact with the heated wire. Therefore, there exists a safety defect in prior styrofoam cutting machines.

### SUMMARY OF THE INVENTION

The object of the present invention is to correct the safety defect that exists in prior styrofoam board cutting machines by providing a safer machine that prevents workers from making contact with the heated wire during operation.

In an aspect, the present invention provides a styrofoam board cutting machine comprised of a working platform, a support arm (or support frame) fixed to the working platform, and a heating wire set on the end portion of the support arm, wherein a protective mantle is positioned around the heated wire on the support arm.

In another aspect of the present invention, the protective mantle has an upper opening that connects to the end portion of the support arm and a lower opening that is directed downwards to the working platform; the size of the upper opening being smaller than the lower opening.

In another aspect of the present invention, the protective mantle is concaved on the sides, and having an upper opening circular in shape, and the lower opening square-like.

In another aspect of the present invention, the protective mantle is conical or, alternatively, bowl-shaped.

In other aspects of the styrofoam board cutting machine, the protective mantle can be made of transparent material or, alternatively, grid-like or latticed material.

One of the benefits of the styrofoam board cutting machine according to an embodiment of the present invention is that the machine can prevent the operator from accidentally coming into contact with the high temperature wire by having the protective mantle around the heating wire. In addition, because the protective mantle is made of transparent material or a mesh/latticed material, the operator can monitor the progress of the heating wire through the mantle and therefore decrease the amount of defects and inferior products. A further benefit of the present invention is that the structure of the machine is very simple and the cost of manufacturing is very low.

These and other embodiments of the present invention are further made apparent, in the remainder of the present document, to those of ordinary skill in the art.

### BRIEF DESCRIPTION OF THE DRAWINGS

In order to more fully describe embodiments of the present invention, reference is made to the accompanying drawings. These drawings are not to be considered limitations in the scope of the invention, but are merely illustrative.

FIG. 1 is a structural view of a first embodiment of the styrofoam board cutting machine in accordance with the present invention.

FIG. 2 is a side view of the first embodiment of the styrofoam board cutting machine in accordance with the present invention.

FIG. 3 is a structural view of a second embodiment of the styrofoam board cutting machine in accordance with the present invention.

FIG. 4 is a structural view of a third embodiment of the styrofoam board cutting machine in accordance with the present invention.

FIG. 5 is a structural view of a grid-like or latticed protective mantle of the styrofoam board cutting machine in accordance with the present invention.

### DETAILED DESCRIPTION OF SPECIFIC EMBODIMENTS

The description above and below and the drawings of the present document focus on one or more currently preferred embodiments of the present invention and also describe some exemplary optional features and/or alternative embodiments. The description and drawings are for the purpose of illustration and not limitation. Those of ordinary skill in the art would recognize variations, modifications, and alternatives. Such variations, modifications, and alternatives are also within the scope of the present invention.

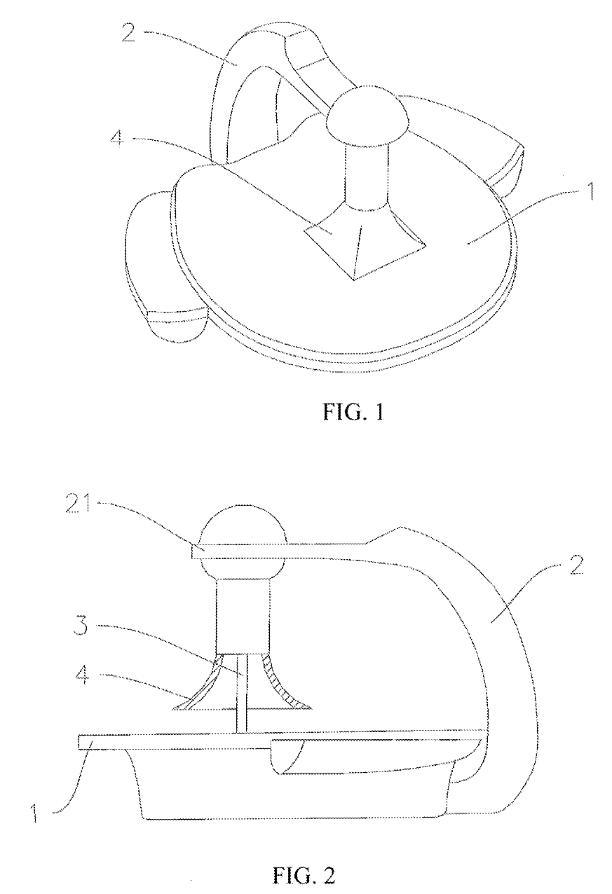

As shown in FIG. 1 and FIG. 2, in a first embodiment of the present invention, the styrofoam cutting machine is comprised of a working platform 1, a support arm 2, a heating wire 3, and a protective mantle 4. The flat upper surface of the working platform 1 is where the styrofoam to be cut is placed. The support arm 2 is fixed to one side of platform 1 and extends upwards along the center of the working platform 1. An installation portion 21 is set on the end of the support arm. The heating wire 3 is attached in line to the installation portion 21 at the end of the support arm 2, and the wire 3 is drilled through a hole on the surface of the platform 1 and extends into the platform 1. The protective mantle is a covering with an upper opening and a lower opening; the upper opening is fixed to the installation portion 21 at the end of the support arm 2, and the lower opening is directed downwards to the working platform. The size of the upper opening is smaller than the lower opening. The protective mantle 4 is arranged so that it is surrounding the heating wire 3.

The upper opening of the protective mantle 4 is extended upwards to form a cylindrical wall, an inner and outer screw thread is located on the cylindrical wall and the cylindrical end of the support arm respectively. The protective mantle 4 is fixed on the end of the support arm 2 by screwing the screw threads together. There is a space left in between the bottom of the protective mantle 4 and the working platform 1 to allow the styrofoam board to move during processing. An orientation piece is attached to the cylindrical wall of the protective mantle 4 to fix the support arm 2 on the protective mantle 4. The orientation piece could be a bolt, a jack bolt, or any other fastener that can restrict the cylindrical wall from revolving relative to the surface of the cylindrical end of the support arm 2.

The horizontal section of the upper portion of the protective mantle 4 is circular in shape, and the horizontal section of the lower portion of the protective mantle 4 is square. The shape of the mantle as a whole is one that transitions from the circular upper part to the square lower part with concave side faces. While the heated wire is cutting a styrofoam board, the protective mantle helps avoid accidents by preventing the operator from touching the hot wire and being burned while moving the styrofoam work pieces, thereby making the operation safer.

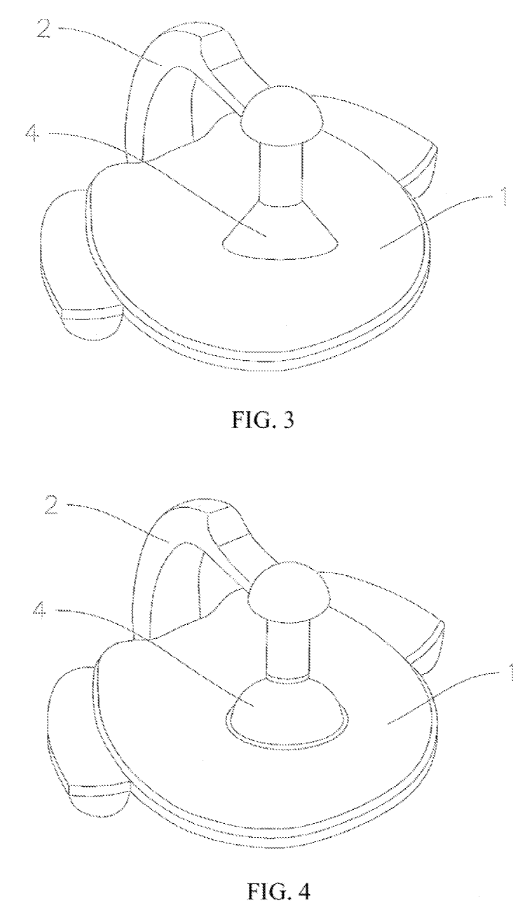

FIG. 3 shows a second embodiment of the styrofoam board cutting machine of the present invention. A difference between the first and the second embodiment is the shape of the protective mantle; in the second embodiment, the mantle is conical, with openings at both the top and bottom. The upper and lower horizontal openings of the cone shaped mantle are circular, and the diameter of the upper circle is smaller than the lower one. This embodiment of the styrofoam board cutting machine can prevent burn accidents as well.

FIG. 4 shows a third embodiment of the styrofoam board cutting machine of the present invention where the protective mantle is bowl-shaped.

The shape of the protective mantle in the above-mentioned first, second and third embodiment can be any other shapes as long as the upper opening is smaller than the lower opening.

In the above embodiments, the protective mantle is made of a transparent material such as transparent plastic, acrylics or other similar material. During operation, workers can watch over the working status of the heated wire through the transparent mantle, such that the number of defects or inferior products can be decreased while increasing efficiency at the same time.

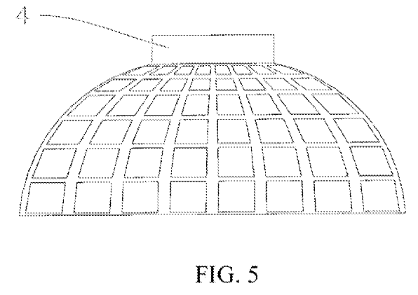

As shown in FIG. 5, an embodiment of the protective mantle can be made of a wire netting entwined grid-like or similar latticed material; because of the numerous openings in the mantle material the operator can monitor the status of the heating wire while being protected from contacting the heated wire at the same time. This achieves the same result as when the protective mantle is made of transparent material. Such a protective mantle can also be made by cutting a plurality of holes of the same or similar size in the mantle.

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments of the foregoing description, but rather is indicated by the appended claims. All changes that come within the meaning and range of equivalents within the claims are intended to be considered as being embraced within the spirit and scope of the claims.

What is claimed is:

1-7. (canceled)

8. A styrofoam cutting machine comprising: a working platform, a support arm fixed on the working platform, and a heating wire attached to an end of the support arm, wherein a protective mantle is positioned around the heating wire on said support arm.

9. The styrofoam cutting machine according to claim 8, wherein said protective mantle has an upper opening connecting to the end of said support arm and a lower opening directed downwards toward the working platform, wherein the upper opening is smaller than the lower opening.

10. The styrofoam cutting machine according to claim 9, wherein said protective mantle comprises concaved side faces, a circular shaped upper part and a square shaped lower part.

11. The styrofoam cutting machine according to claim 9, wherein said protective mantle is conical.

12. The styrofoam cutting machine according to claim 9, wherein said protective mantle is bowl-shaped.

13. The styrofoam cutting machine according to claim 8, wherein said protective mantle is made of a transparent material.

14. The styrofoam cutting machine according to claim 9, wherein said protective mantle is made of a transparent material.

15. The styrofoam cutting machine according to claim 10, wherein said protective mantle is made of a transparent material.

16. The styrofoam cutting machine according to claim 11, wherein said protective mantle is made of a transparent material.

17. The styrofoam cutting machine according to claim 12, wherein said protective mantle is made of a transparent material.

18. The styrofoam cutting machine according to claim 8, wherein said protective mantle is made of a mesh shaped or latticed material.

19. The styrofoam cutting machine according to claim 9, wherein said protective mantle is made of a mesh shaped or latticed material.

20. The styrofoam cutting machine according to claim 10, wherein said protective mantle is made of a mesh shaped or latticed material.

21. The styrofoam cutting machine according to claim 11, wherein said protective mantle is made of a mesh shaped or latticed material.

22. The styrofoam cutting machine according to claim 12, wherein said protective mantle is made of a mesh shaped or latticed material.

23. A styrofoam cutting machine comprising: a working platform, a support arm fixed on the working platform, and a heating wire attached to an end of the support arm, wherein a protective mantle is positioned around the heating wire on said support arm, wherein said protective mantle has an upper opening connecting to the end of said support arm and a lower opening directed downwards toward the working platform, wherein the upper opening is smaller than the lower opening.

24. The styrofoam cutting machine according to claim 23, wherein the upper opening of the protective mantle comprises a cylindrical wall connected to the end of the support arm by a fastener that restricts the cylindrical wall from revolving relative to a surface at the end of the support arm.

25. The styrofoam cutting machine according to claim 23, wherein said protective mantle comprises concaved side faces, a circular shaped upper part and a square shaped lower part.

26. The styrofoam cutting machine according to claim 23, wherein said protective mantle is made of a transparent material.

27. The styrofoam cutting machine according to claim 23, wherein said protective mantle comprises a surface having a plurality of openings.
